(19) United States
(12) Patent Application Publication
(10) Pub. No.: US 2017/0043819 A1
(43) Pub. Date: Feb. 16, 2017

(54) ROLLER ASSEMBLY OF AN UNDERCARRIAGE SYSTEM

(71) Applicant: Caterpillar Global Mining LLC, South Milwaukee, WI (US)

(72) Inventors: Cheng-Kong C. Wu, Franklin, WI (US); Gregory H. Dubay, Carlock, IL (US)

(73) Assignee: Caterpillar Global Mining LLC, South Milwaukee, WI (US)

(21) Appl. No.: 15/333,428

(22) Filed: Oct. 25, 2016

(51) Int. Cl. B62D 55/15

(52) U.S. Cl. CPC B62D 55/15; B62D 55/10

(57) ABSTRACT

The disclosure provides a roller assembly for an undercarriage system of a machine. The undercarriage system includes a frame, which has a first inner surface defining a first opening. The roller assembly includes a roller supported on a roller shaft, and a spacer assembly. The spacer assembly includes a boss and a pad. The boss includes a second inner surface defining a second opening. The boss is fixedly attached to the frame, such that the second opening axially aligns with the first opening of the frame. The pad includes a third inner surface defining a third opening. The pad has a relatively greater hardness than the boss. The pad is fixedly attached to the boss, such that the third opening axially aligns with the second opening. Further, the roller shaft extends through the first opening, the second opening, and the third opening, to support the roller on the frame.

### TECHNICAL FIELD

The present disclosure generally relates to an undercarriage system of a machine. More particularly, the present disclosure relates to a roller assembly of the undercarriage system.

### BACKGROUND

Various machines are known to employ an undercarriage system, for machine maneuvering. The undercarriage system typically includes a track chain arrangement rotatably supported on a frame. The track chain arrangement is rotated over the frame, to facilitate machine maneuvering. Additionally, the undercarriage system employs a number of roller assemblies. The roller assemblies support and guide the track chain arrangement on the frame, while the track chain arrangement rotates over the frame.

Conventionally, each of the roller assemblies includes a roller and two spacer assemblies. The roller employs a roller shaft, which supports the roller on openings in the frame of the undercarriage system. The roller is typically positioned spaced apart from the frame, with use of the spacer assemblies. More specifically, each spacer assembly is positioned on each side of the roller, to space each side of the roller from the frame. Each spacer assembly includes a boss and a thrust washer. The boss is welded to the frame. The thrust washer is disposed between the boss and the roller. During field operations, the thrust washer may be worn out by the rollers. This may lead to a contact between the roller and the boss, which may in turn initiate wear and tear of the boss. Replacement and servicing of the boss may require several processes, such as, cutting off the boss, grinding a surface of the frame, and welding a new boss. Therefore, replacement and servicing of the boss is a cumbersome and time intensive process, leading to undesirable stalling of the field operations.

Hence, there is a need for an improved spacer assembly to preclude the wearing of the boss and shorten the servicing time.

### SUMMARY OF THE DISCLOSURE

Various aspects of the present disclosure provide a roller assembly for an undercarriage system of a machine. The undercarriage system includes a frame. The frame has a first inner surface defining a first opening through the frame. The roller assembly includes a roller and a spacer assembly. The roller is supported on a roller shaft. The spacer assembly includes a boss and a pad. The boss includes a second inner surface defining a second opening. The boss is fixedly attached to the frame, such that the second opening axially aligns with the first opening of the frame. The pad includes a third inner surface defining a third opening. The pad includes a relatively greater hardness than the boss. The pad is fixedly attached to the boss, such that the third opening axially aligns with the second opening. Further, the roller shaft extends through the first opening, the second opening, and the third opening, to support the roller on the frame.

### BRIEF DESCRIPTION OF THE DRAWINGS

FIG. 1 is a side view of an undercarriage system, in accordance with the concepts of the present disclosure;

FIG. 2 is a top view of a portion of the undercarriage system of FIG. 1, illustrating an arrangement between a roller support portion of a frame and a roller assembly of the undercarriage system, in accordance with the concepts of the present disclosure;

FIG. 3 is a sectional view of the portion of the undercarriage system of FIG. 1, illustrating the arrangement between the roller support portion of the frame and the roller assembly, in accordance with the concepts of the present disclosure; and

FIG. 4 is a perspective view of a spacer assembly of the roller assembly, illustrating an assembly of a pad and a boss with the frame of the undercarriage system, in accordance with the concepts of the present disclosure.

### DETAILED DESCRIPTION

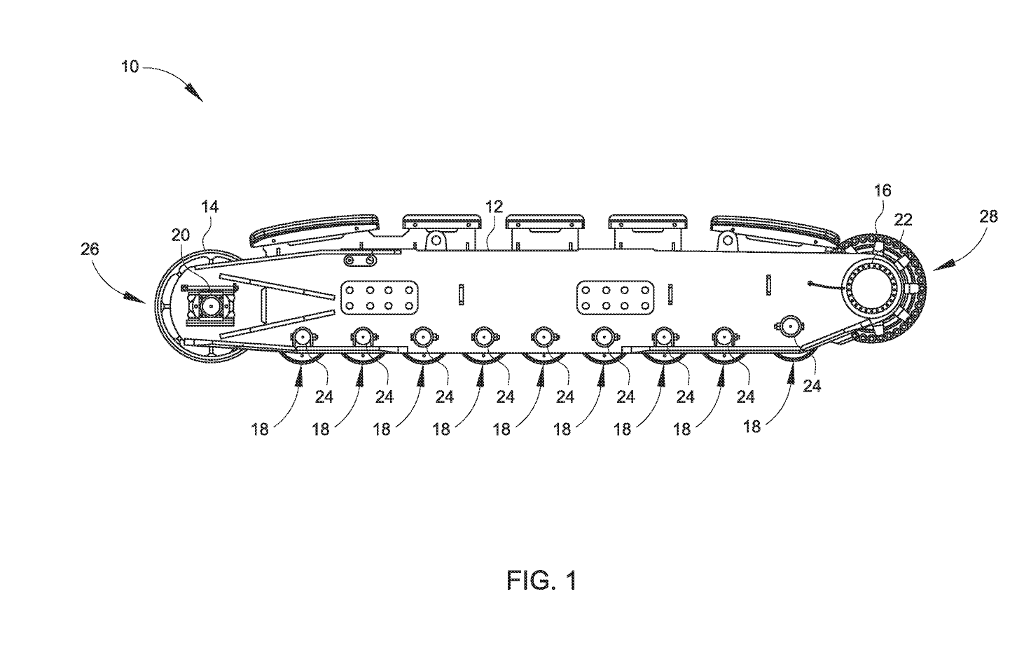

Referring to FIG. 1, there is shown a side view of an exemplary track-type undercarriage system 10 of a machine (not shown). The machine (not shown) may embody any construction machine employing the undercarriage system 10, such as but not limited to, a track-type tractor, a track-type loader, a track-type excavator, and a track-type shovel. The undercarriage system 10 maneuvers the machine (not shown) from one place to another. The undercarriage system 10 includes a frame 12, an idler 14, a power sprocket 16, a track chain arrangement (not shown), and a number of roller assemblies 18.

The frame 12 is a support structure that supports various other components of the undercarriage system 10. More specifically, the frame 12 supports the idler 14, the power sprocket 16, and the roller assemblies 18 of the undercarriage system 10. The frame 12 includes an idler support portion 20, a sprocket support portion 22, and a number of roller support portions 24.

The idler support portion 20 of the frame 12 is positioned proximal to a front end 26 of the undercarriage system 10. The idler support portion 20 rotatably supports the idler 14, proximal to the front end 26 of the undercarriage system 10.

The sprocket support portion 22 of the frame 12 is positioned proximal to a rear end 28 of the undercarriage system 10. The sprocket support portion 22 rotatably supports the power sprocket 16, proximal to the rear end 28 of the undercarriage system 10. Notably, the track chain arrangement (not shown) passes over the idler 14 and the power sprocket 16. The power sprocket 16 drives the track chain arrangement (not shown), to facilitate machine maneuvering.

The roller support portions 24 of the frame 12 are positioned between the idler support portion 20 and the sprocket support portion 22. The roller support portions 24 support the roller assemblies 18 of the undercarriage system 10. The roller assemblies 18, in turn, support the track-chain arrangement (not shown), during machine maneuvering. For ease in reference and understanding, an arrangement 30 (Shown in FIG) between a singular roller support portion 24 and a singular roller assembly 18, will be explained in detail hereinafter. Similar arrangement between other roller support portions 24 and other roller assemblies 18, may also be contemplated.

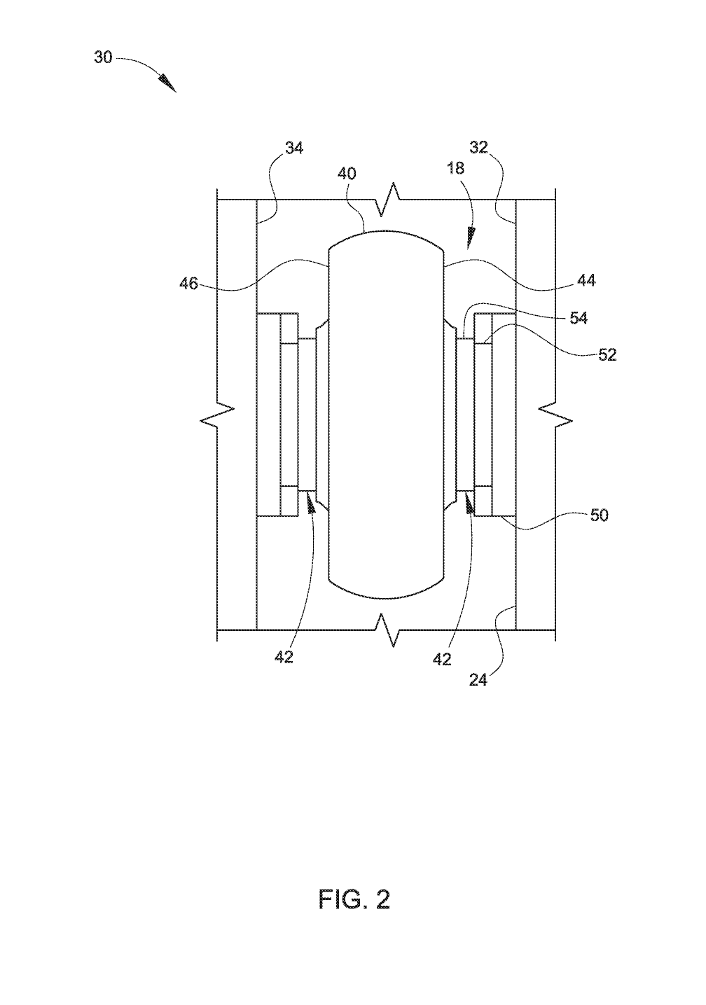

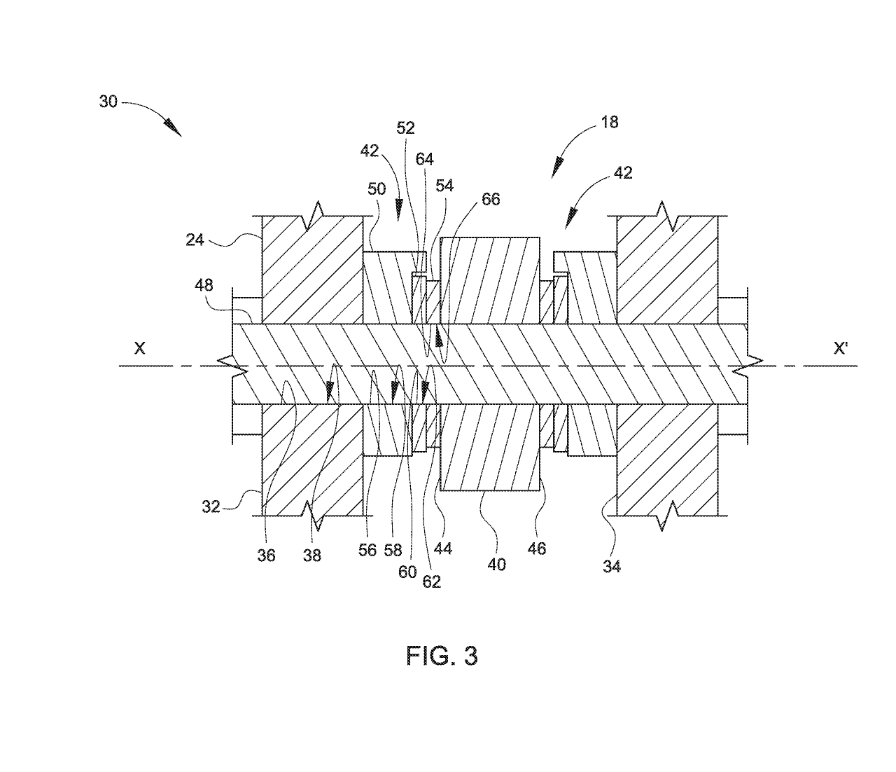

Referring to FIGS. 2 and 3, there is shown the arrangement 30 between the roller support portion 24 of the frame 12 and the roller assembly 18. The roller support portion 24 of the frame 12 includes a first side section 32 and a second side section 34. Each of the first side section 32 and the second side section 34 includes a first inner surface 36 (FIG. 3) that defines a first opening 38 (FIG. 3) in the frame 12.

The roller assembly 18 includes a roller 40 and two spacer assemblies 42. The roller 40 includes a first side surface 44 and a second side surface 46. The roller 40 is mounted on a roller shaft 48 (FIG. 3). The roller shaft 48 (FIG. 3) is rotatably supported on the first side section 32 and the second side section 34, to support the roller 40 on the roller support portion 24 of the frame 12. Moreover, the roller 40 is positioned spaced from the first side section 32 and the second side section 34 of the frame 12, with use of the spacer assemblies 42.

The spacer assemblies 42 maintain a clearance space between the roller 40 and the frame 12. More specifically, one spacer assembly 42 maintains a clearance space between the first side surface 44 of the roller 40 and the first side section 32 of the roller support portion 24 of the frame 12. Another spacer assembly 42 maintains a clearance space between the second side surface 46 of the roller 40 and the second side section 34 of the roller support portion 24 of the frame 12. For ease in reference and understanding structure and arrangement of a singular spacer assembly 42, which maintains the clearance space between the first side surface 44 and the first side section 32, will be described in details hereinafter. Similar structure and arrangement of the other spacer assembly 42, which maintains the clearance space between the second side surface 46 and the second side section 34, may also be contemplated.

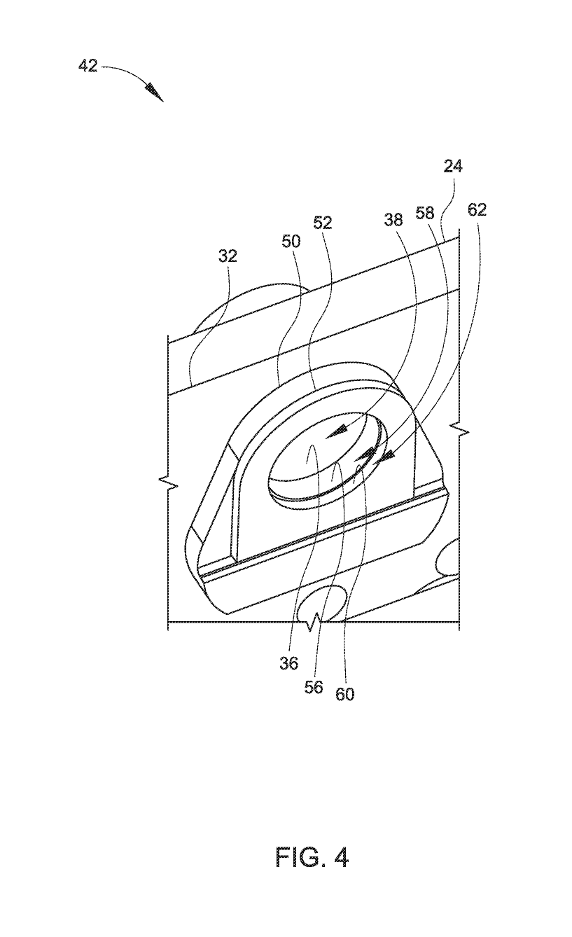

Referring to FIGS. 2, 3, and 4, there is shown the spacer assembly 42 of the roller assembly 18. The spacer assembly 42 includes a boss 50, a pad 52, and a thrust washer 54. The boss 50 of the spacer assembly 42 includes a second inner surface 56 (FIGS. 3 and 4) that defines a second opening 58 (FIGS. 3 and 4) in the boss 50. The boss 50 is fixedly attached to the first side section 32, such that the second opening 58 (FIGS. 3 and 4) in the boss 50 axially aligns with the first opening 38 in the first side section 32 of the roller support portion 24 of the frame 12. The second opening 58 in the boss 50 aligns with the first opening 38 in the first side section 32, along a central axis X-X′. An attachment means between the boss 50 and the first side section 32 includes, but is not limited to, a weld attachment, a rivet attachment, an adhesive attachment, and a bolt attachment.

The pad 52 of the spacer assembly 42 includes a third inner surface 60 (FIGS. 3 and 4) that defines a third opening 62 (FIGS. 3 and 4) in the pad 52. The pad 52 includes a relatively greater hardness than the boss 50. The pad 52 is fixedly attached to the boss 50, such that the third opening 62 (FIGS. 3 and 4) in the pad 52 axially aligns with the second opening 58 (FIGS. 3 and 4) in the boss 50. The third opening 62 (FIGS. 3 and 4) in the pad 52 axially aligns with the second opening 58 (FIGS. 3 and 4) in the boss 50, along the central axis X-X′. In an embodiment, the pad 52 is replaceable, when required. An attachment means between the pad 52 and the boss 50 includes, but is not limited to, a weld attachment, a rivet attachment, an adhesive attachment, and a bolt attachment.

Referring to FIGS. 2 and 3, the thrust washer 54 of the spacer assembly 42 includes a fourth inner surface 64 (FIG. 3) that defines a fourth opening 66 (FIG. 3) in the thrust washer 54. The thrust washer 54 is positioned in abutment with the pad 52, such that the fourth opening 66 (FIG. 3) in the thrust washer 54 axially aligns with the third opening 62 (FIGS. 3 and 4) in the pad 52, along the central axis X-X′. The thrust washer 54 is sandwiched between the pad 52 and the first side surface 44 of the roller 40. More specifically, in assembly, the roller shaft 48 (FIG. 3) sequentially passes through the fourth opening 66 in the thrust washer 54, the third opening 62 (FIGS. 3 and 4) in the pad 52, the second opening 58 (FIGS. 3 and 4) in the boss 50, and the first opening 38 (FIGS. 3 and 4) in the first side section 32 of the roller support portion 24 of the frame 12, to support the roller 40 on the first side section 32 of the roller support portion 24 of the frame 12. In an embodiment, the roller shaft 48 (FIG. 3) extends beyond the first side section 32, to be locked at the first side section 32 of the roller support portion 24 of the frame 12 by a pin lock arrangement (not shown). Therefore, the spacer assembly 42 maintains a clearance space between the roller 40 and the first side section 32 of the roller support portion 24 of the frame 12. Similar structure and arrangement of the other spacer assembly 42, maintains the clearance space between the second side surface 46 and the second side section 34.

### INDUSTRIAL APPLICABILITY

In operation, the undercarriage system 10 is employed to maneuver the machine (not shown). More specifically, the power sprocket 16 of the undercarriage system 10 is connected to and driven by a hydraulic motor (not shown). The power sprocket 16 drives the track-chain arrangement (not shown) over the idler 14 and the roller assemblies 18, to facilitate machine maneuvering. During such operation, the roller assemblies 18 support and guide the track-chain arrangement (not shown). For ease in reference and understanding, concepts of the present disclosure will be discussed as applied to a singular roller assembly 18. It may be contemplated that the concepts of the present disclosure may also be applied to other roller assemblies 18.

The roller assembly 18 includes the roller 40 and two spacer assemblies 42. One spacer assembly 42 maintains a clearance space between the first side surface 44 of the roller 40 and the first side section 32 of the roller support portion 24 of the frame 12. Similarly, another spacer assembly 42 maintains a clearance space between the second side surface 46 of the roller 40 and the second side section 34 of the roller support portion 24 of the frame 12. For ease in reference, structure and arrangement of the spacer assembly 42, which maintains the clearance space between the first side surface 44 of the roller 40 and the first side section 32 of the roller support portion 24, will be discussed in details hereinafter.

The spacer assembly 42 includes the boss 50, the pad 52, and the thrust washer 54. The boss 50 is fixedly attached to the first side section 32 of the roller support portion 24 of the frame 12. The pad 52 is fixedly attached to the boss 50. The thrust washer 54 is positioned in abutment with the pad 52. Further, the roller shaft 48 passes through the fourth opening 66 in the thrust washer 54, the third opening 62 in the pad 52, the second opening 58 in the boss 50, and the first opening 38 in the first side section 32, to support the roller 40 on the first side section 32 of the roller support portion 24 of the frame 12.

During prolonged and continuous operations, the thrust washer 54 may be worn out. In such situations, the first side surface 44 of the roller 40 engages with the pad 52. As the pad 52 has a relatively greater hardness than the boss 50, the pad 52 is minimally worn. This avoids wear of the boss 50 and thus prolongs a work life of the boss 50 of the spacer assembly 42. A prolonged work life of the boss 50 avoids a cumbersome and time-consuming service and replacement of the boss 50 of the spacer assemblies 42. Therefore, such spacer assemblies 42 reduces service time, reduces service effort, and increases work life of the components.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claim(s) and any equivalents thereof.

What is claimed is:

1. A roller assembly for an undercarriage system of a machine, the undercarriage system including a frame having a first inner surface defining a first opening therethrough, the roller assembly comprising:
a roller supported on a roller shaft; and
a spacer assembly, including:
a boss including a second inner surface defining a second opening, the boss being fixedly attached to the frame such that the second opening axially aligns with the first opening of the frame; and
a pad including a third inner surface defining a third opening, the pad being fixedly attached to the boss such that the third opening axially aligns with the second opening, wherein the pad includes a relatively greater hardness than the boss;
wherein the roller shaft extends through the first opening, the second opening, and the third opening, to support the roller on the frame.
